(19) United States
(12) Patent Application Publication
(10) Pub. No.: US 2010/0180311 A1
(43) Pub. Date: Jul. 15, 2010

(54) Method and Apparatus for Broadcasting, Displaying, and Navigating Internet Broadcasts

(76) Inventor: Leroy Gordon, Brooklyn, NY (US)

Correspondence Address: COOPER & DUNHAM, LLP, 30 Rockefeller Plaza, 20th Floor, NEW YORK, NY, 10112, US

(21) Appl. No.: 12/650,929

(22) Filed: Dec. 31, 2009

Related U.S. Application Data
(60) Provisional application No. 61/141,944, filed on Dec. 31, 2008.

(51) Int. Cl. H04N 5/445; G06F 15/16; G06Q 30/00

(52) U.S. Cl. 725/61; 709/231; 705/14.54; 705/14.49

(57) ABSTRACT

The invention provides a method and apparatus for broadcasting, displaying, and navigating Internet broadcasts comprising providing an Internet application; streaming to the application a plurality of channels of multimedia content over a broadband connection; forwarding for display a first channel featuring selected media content on a video monitor of a screen attached to a personal computer or of the broadband capable receiver or display; and allowing a user to select and display a second or subsequent channel after displaying the media content on the first channel, wherein the user can navigate through the plurality of channels while viewing the media content featured on each channel in full screen on the display device.

### CROSS-REFERENCE TO RELATED APPLICATION

This application claims priority of provisional application U.S. Ser. No. 61/141,944, filed Dec. 31, 2008, the contents of which are incorporated herein by reference.

### FIELD OF THE INVENTION

The present disclosure relates generally to a method and apparatus or broadcasting, displaying and navigating Internet broadcasts.

### BACKGROUND OF THE INVENTION

Recent advances in technology have made it possible for viewers to watch entertaining video clips, favorite television shows, and other broadcasts over a broadband connection using a personal computer or other broadband enabled device. A number of systems have been created and developed that allow users to view such media content through Internet websites, for example, YouTube®, Hulu, and Joost®. These systems typically allow a user to search for specific media content and then view the content on their computer over a broadband connection.

However, these systems have a number of significant shortcomings. First and primarily, these systems do not provide the user with a seamless viewing experience. In other words, these systems require that the user search for specific content every time he wishes to view a different program, for example, by entering specific keywords or by scrolling through available media content. These other systems do not provide the user with the ability to simply “change channels” to view additional media content, as if the user were viewing the programs on an actual television. This impairs these systems' ability to provide such services in a way that is competitive with the services offered by traditional broadcast sources such as broadcast television, cable, and satellite. Further, users who are not comfortable with computer equipment can find the viewing experience confusing or frustrating, causing them to lose interest.

Second, there is a certain enjoyment in the traditional television viewing experience that is lost with the current systems. Turning on a traditional television channel just to see what is being broadcast, or “tuning in” to a program offered at a specific time is a conventional and long standing habit. Other Internet media broadcast systems do not offer this familiar experience. In fact, the experience offered by the other systems seems hyper-technical by nature. For instance, word searches or menus must be used to find a show. Searching for programs in this manner can be more tedious and confusing than, for instance, simply switching to a particular channel that offers programming desirable to the viewer. Even if random clips are offered for viewing, user assent is required. All of these factors change the character of the viewing experience to something that is quite unlike traditional television.

Third, these systems often require the user to download and install proprietary software (i.e., their designated media player) before the user can view the broadcasts. The viewer is also forced to download a new player or application every time the system is updated in order to receive the latest features of the system. This creates a tedious experience for the user, an often frustrating experience for a user who is inexperienced with computer equipment, and opens the user up to viruses or spyware that may affect the computer.

Finally, these services do not effectively take advantage of video advertisements and content. These services typically play random commercials before, during, or in between broadcasts. However, these commercials and advertisements are not targeted to the interests of the specific user, and thus do not effectively engage users to purchase a product or service while viewing the media content.

Accordingly, it is desirable to provide a computerized system and method that simulates a traditional television viewing experience by enabling viewers/users to watch broadcasts over the Internet on a personal computer or other Internet capable device, without encountering the limitations of the foregoing systems and methods, primarily by enabling users seamlessly to view Internet broadcasts by navigating through channels displaying media content while continuously viewing the media content in full screen, thereby emulating the experience provided by traditional broadcast television, cable or satellite and thusly creating the fourth wave of television know as Internet Television (Internet TV), Broadband Television (Broadband TV) or Internet Protocol Television (IPTV)

### SUMMARY OF THE INVENTION

The present invention addresses many of the shortcomings associated with the available systems. The invention provides methods and apparatuses for transmitting, displaying, and navigating media content over a broadband connection wherein a user can navigate through channels displaying media content while viewing the media content in full screen format on a personal computer or other broadband enabled device.

The invention also provides a method for transmitting, displaying, and navigating Internet broadcasts. According to one embodiment of the present disclosure, the method comprises providing an Internet application; streaming to the application a plurality of channels, each channel featuring multimedia content over a broadband connection; displaying a first channel featuring selected media content on a video monitor or a screen attached to a personal computer; and allowing a user to select and display a second channel replacing the media content of the first channel. The user can navigate through a plurality of channels while viewing and interacting with the media content featured on each channel on a full screen on the personal computer or other broadband enabled devices.

The invention further provides an apparatus for transmitting, displaying, and navigating Internet broadcasts. Another embodiment of the present invention includes an Internet application; a plurality of channels, each channel featuring media content and/or any Internet or Web addressable resource/object; and a video monitor of a screen attached to a personal computer wherein a user can navigate through the plurality of channels while viewing the media content featured on each channel in full screen on the video monitor screen attached to the personal computer.

The invention additionally provides an apparatus for broadcasting, displaying, and navigating a plurality of Internet video streams comprising at least one server having software for providing and supporting a service provides an internet website with access to a plurality of choices among different media content; the server also having software for navigating between media content choices by offering a selection of assigned numbers or symbols representing media content choices; wherein the server provides user screens that permit navigation through the plurality of choices using assigned choice identifier numbers or symbols, or using up or down arrow keys, whereby selecting media content choices resembles conventional television channel selection.

### BRIEF DESCRIPTION OF THE DRAWINGS

The features and advantages of the present invention can be more readily understood from the following detailed description of the preferred embodiments taken with reference to the accompanying drawings wherein:

FIG. 1 shows a block diagram illustrating a system for broadcasting, displaying, and navigating Internet broadcasts, according to one embodiment of the present invention;

FIG. 2 shows an exemplary embodiment of a user interface or launch screen for use in the present invention through which a user can access the service;

FIG. 3 is a flowchart illustrating how an individual may obtain access to a service for broadcasting, displaying and navigating Internet broadcasts, according to one embodiment of the present invention;

FIG. 4 shows an exemplary embodiment of a screen that is activated when a user chooses to subscribe to the service;

FIG. 5 shows an exemplary embodiment of a screen that is activated when a user chooses to run a software application;

FIG. 6 is a diagram showing an exemplary embodiment of the user interface software application which runs virtually on a user's broadband enabled device;

FIG. 7 is a flowchart demonstrating how a subscriber accesses the premium media service;

FIG. 8 is a flowchart demonstrating how advertisements shown to a user are specifically targeted to the specific individual; and

FIG. 9 illustrates an exemplary computer system capable of implementing the methods and apparatuses of the present disclosure.

### DETAILED DESCRIPTION OF THE PREFERRED EMBODIMENTS

The invention provides a method for broadcasting, displaying, and navigating Internet broadcasts comprising: (a) providing an Internet application; (b) displaying a sign-on screen to permit user identification; (c) permitting a user to sign on; (d) streaming to the user a plurality of channels, each channel featuring media content over a broadband connection to a user location; (e) permitting the user to select a first media content choice or channel featuring media content for display; (f) forwarding for display the first channel or media content choice on a video monitor or display connected to a personal computer or other broadband capable receiver or display; and (g) forwarding for display a second or subsequent channel or media content choice sequentially in response to user selection, wherein the user can navigate through the plurality of channels while viewing the media content featured on each channel in full screen format on the display of the user.

In one embodiment, the user can navigate through the channels by using keys on a keyboard, for example, or can navigate through the channels by using a joystick, remote control or voice control. In another embodiment, the media content is a video stream, audio stream, live broadcast, scheduled programming. Internet telephony, instant messaging, video conferencing, on-demand programming, or pay-per-view programming, or other addressable Internet resource or object. In another embodiment, the user can interact with other users while viewing selected media content using Internet telephony, instant messaging, or video conferencing. In still another embodiment, user feedback is integrated with the media, and user information and actions are collected, reported, relayed, and received and stored or recorded.

In yet another embodiment, interactive marketing, advertising and merchandising is provided on a portion of the display screen, such as the upper, lower, or side portions of the display screen and this marketing, advertising and merchandising is specifically targeted to the user based on information collected about the user. The media content is displayed in regular or high definition format as desired by the user. In an additional embodiment, user feedback is integrated with the media.

The invention also provides an apparatus for broadcasting, displaying, and navigating o Internet broadcasts comprising an Internet application, a plurality of channels or selections featuring media content; and a video monitor or a screen attached to a personal computer or other broadband capable video receiver and display; wherein a user can navigate through the plurality of channels or selections sequentially while viewing the media content featured on each channel in full screen on the video receiver and display computer. The apparatus includes means to navigate through the channels using a keyboard, remote control, joystick, or voice control or command. The media content may be displayed in high definition or regular television format, as a video stream, with or without an audio stream, a separate audio stream, a live broadcast, scheduled programming, on-demand programming, or pay-per-view programming.

In one embodiment, the user can interact with other users using Internet telephony, instant messaging, or video conferencing on a particular channel or while viewing the media content. This invention can also collect, record, or receive feedback and information about the users, to help the system select particular advertisements to display. The “targeted advertisement” feature of the invention helps advertisers promote their goods or services more effectively.

The invention also provides an apparatus for broadcasting, displaying, and allowing selection among a plurality of Internet video streams comprising at least one server having software for providing and supporting a service provides an Internet website with access to a plurality of choices among different media content; the server also having software for navigating between media content choices by offering a selection of assigned indicia representing media content choices; wherein the server generates user screens that permit navigation through the plurality of choices by selecting the assigned indicia using a keyboard, a joystick, or other selection means whereby selecting media content choices resembles conventional television channel selection.

Referring now to the drawings, the present invention addresses many of the shortcomings associated with available and proposed systems by providing an environment that enables a user to seamlessly view media content in full screen on a personal computer over a broadband connection in a way that emulates the experience provided by traditional broadcast television. The present disclosure provides tools (in the form of methodologies, apparatuses and systems) for transmitting, displaying, and navigating media content over a broadband connection.

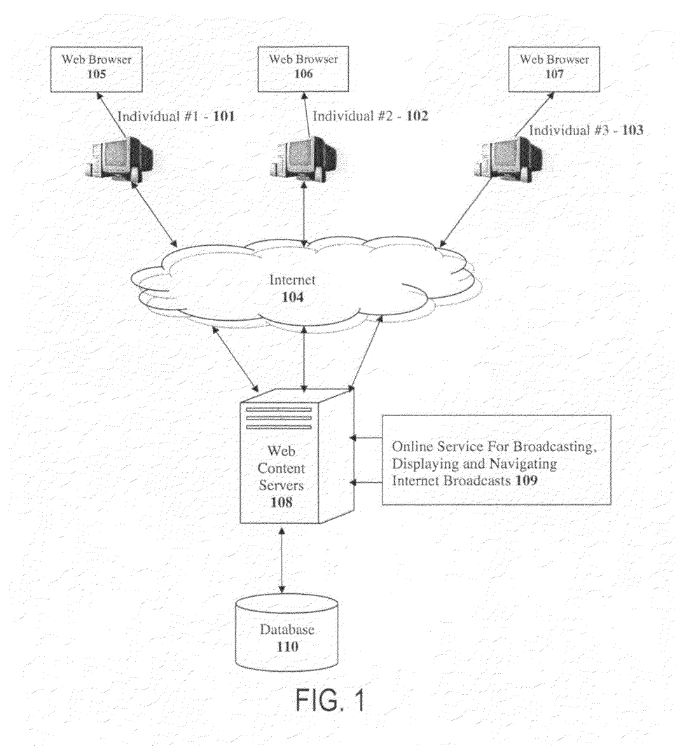

FIG. 1 is a block diagram illustrating a system for transmitting or broadcasting, displaying, and navigating media content over a broadband Internet connection, according to one embodiment of the present disclosure. One or more individuals 101, 102, 103 may access the service via the Internet 104 by using for example, a mobile phone, personal digital assistant, laptop computer, desktop computer, or some other device capable of accessing the Internet over a broadband connection, for example, with a modem, a T1 line, a satellite connection or the like. Requests for media content provided by the service for broadcasting, displaying and navigating Internet broadcasts 109 may be sent by each individual's 101, 102, 103 web browser 105, 106, 107 through the Internet 104 to the web content server 108. The web content server may respond to the requests sent by the web browsers 105, 106, 107 and provide access to the media content provided by the service for broadcasting, displaying and navigating Internet broadcasts 109 through the Internet 104. A database 110 may be used by the service to store information, such as account information or usage habits relating to individuals 101, 102, 103 who subscribe to the service.

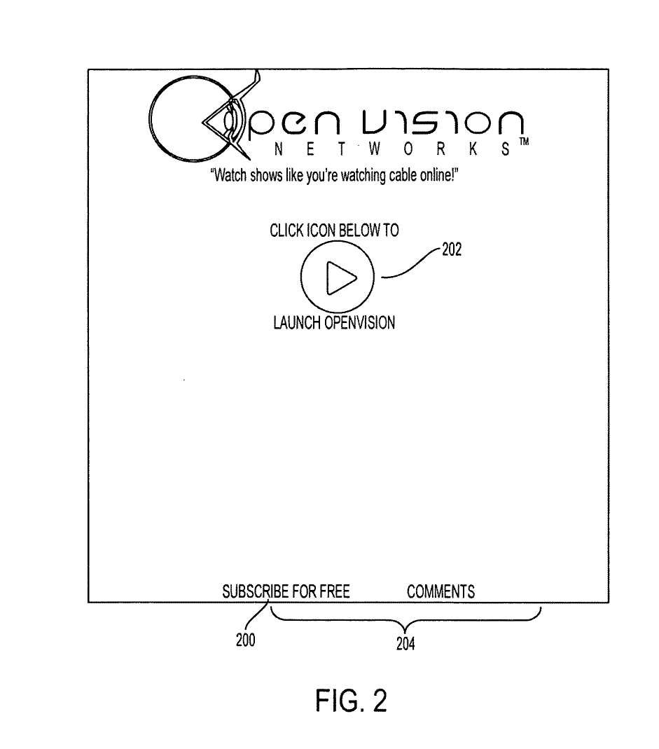

FIG. 2 is a diagram showing an exemplary embodiment of a user interface or launch screen through which a user can access the service. Typically, the user interface is presented within an Internet browser, for example, Microsoft Internet Explorer®. An individual may access the service over the Internet over a broadband connection, by using for example, a mobile phone, personal digital assistant, laptop computer, desktop computer, or any other device capable of accessing the Internet using a broadband connection. The device, such as a personal or laptop computer, may be connected to an accessory video monitor, such as a large screen television to enhance the viewing experience. In the illustrated embodiment, the browser window includes a set of links or icons by which the user can subscribe to the service 200, log in to the service 202, and view information regarding the service 204.

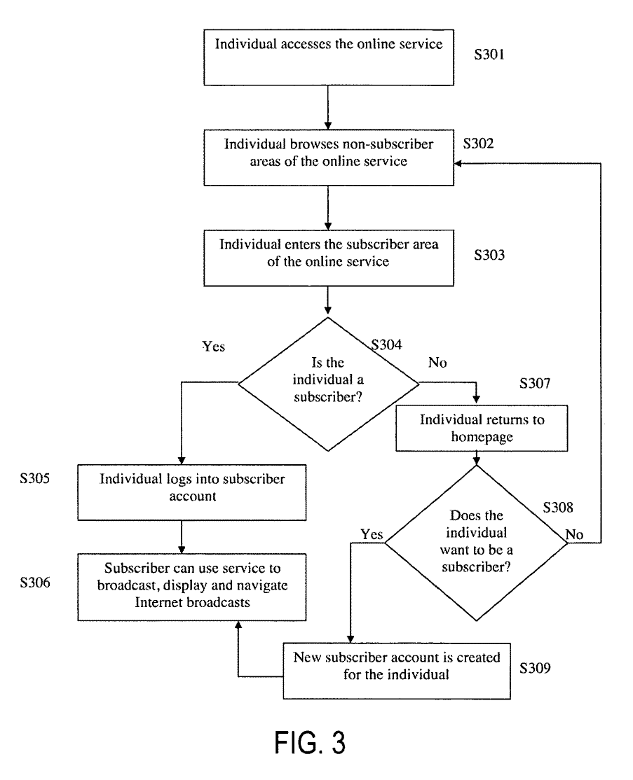

The subscription process will be described with reference to FIGS. 1 and 3. FIG. 3 is a flowchart demonstrating how an individual may subscribe to the service. An individual 101 may access the service 109 through the Internet 104 using a broadband connection (Step S301). The individual 101 may browse the nonsubscriber areas of the service 109 (Step S302), for example, a listing of the available channels, a description of the system, and the terms of use. If the individual 101 enters the subscriber area of the service 109, a verification program residing on the server compares the individual's sign on information to its list of subscribers to determine whether the individual 101 is a subscriber (Step S304). If the individual 201 is a subscriber (Yes, Step S304), the service 109 will log the individual 101 into his/her subscriber account (Step S306) and launch a designated channel. If the individual 101 is not a subscriber (No, Step S307), the individual can return to the launch screen (S308). The user may then choose to subscribe to the service. If the user chooses to subscribe to the service (Yes, Step S309), the user enters specified personal information (name, email address, home or business address, etc.) and the service 209 will then create a new subscriber account for the individual 201. The subscriber may then use the service for receiving, displaying and navigating Internet broadcasts 209 (Step S306).

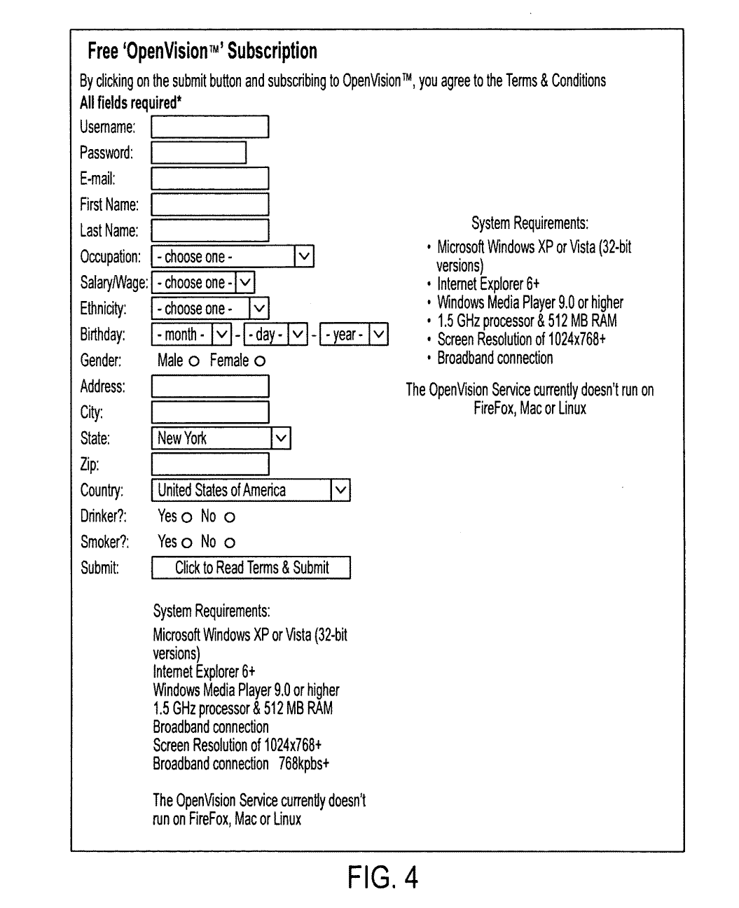

FIG. 4 shows an exemplary embodiment of the page that is activated when the user chooses to subscribe to the service by selecting, for example, the “subscribe” link 200. The user is required to choose a username and password and to enter personal information which can include, for example, name, address, e-mail address, occupation, income range, ethnicity, age, drinking/smoking habits, or recreation or leisure interests. This information is used for targeted marketing and advertising, as will be discussed in further detail below. In one embodiment of the invention, the service also collects and stores securely credit card information in order to use the information to make enable subscribers to select and pay for premium content or merchandise.

When a user chooses to log in to the service by selecting, for example, the “launch OpenVision” icon 202, the user is prompted to run a software application. This software application runs virtually on the user's broadband enabled device. Advantageously, the user is not required to download or install any proprietary software in order to use the present invention. Instead, media content is viewed on the media player currently installed on the user's broadband enabled device, for example, Windows Media Player, VLC media player, and Adobe Flash Player.

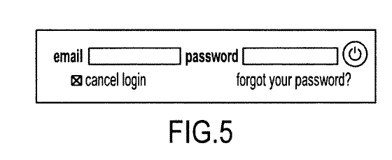

FIG. 5 is a diagram showing an exemplary embodiment of the screen that is activated when the user chooses to run the software application. To sign on to the service, the user is prompted to enter the e-mail address and password he selected when first subscribing to the service. Once the information entered is validated by comparing it to the user profile stored in the database 110, the service is launched. As is customary with sign-in screens, the user can request a sequence of steps to remind him of his password or to send it to his requested e-mail address by choosing the “forgot your password” icon on the sign-in screen.

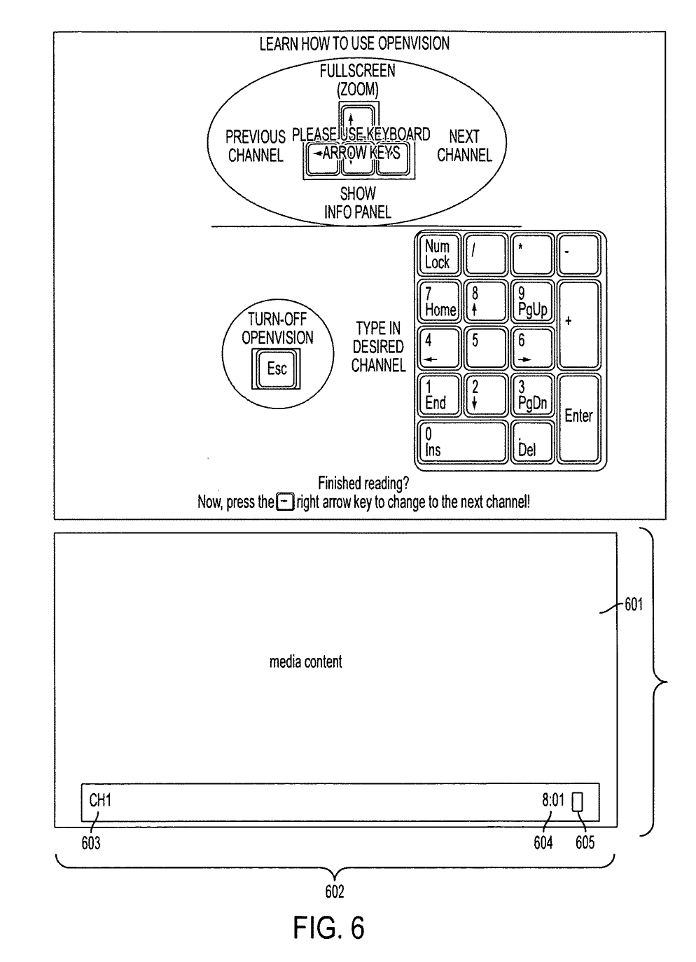

The service uses streaming server software to broadcast media content to a plurality of channels over the Internet to a Content Delivery Network (CDN) for subsequent delivery to the user and/or directly to the user without the use of an intermediary CDN. FIG. 6 is a diagram showing an exemplary embodiment of the user interface software application which runs virtually on the user's broadband enabled device. The user interface 600 displays a designated broadcast 601 that is streaming from the streaming server software in true full-screen format, without browser artifacts such as title bars, scroll bars, status bars, and in standard definition or high definition quality.

In one embodiment of the invention, the user interface includes an information panel, also known as a “lower third display” 602, also shown in FIG. 6. The information panel displays various types of information and content, for example, advertisements, a special announcement, the channel number 603, channel call letters, show title, playing next, time 604, and volume indicator 605. The information panel background can be opaque, translucent or transparent, as desired. The content displayed can be multimedia in nature, for example, videos or animation, and can be interactive in nature, for example, clickable hyperlinks. As should be apparent to a person of ordinary skill, the lower third of the viewing screen or computer monitor provides a number of advantages including flexibility of content. It can provide access to a large number of options and features, including clicks, menus, subscriptions, related websites, icons, “bugs,” animations, banners, advertisements, bulletins, news feeds, or advertisements.

The service allows the user to navigate through a plurality of channels, where each channel displays different media content. Each channel can broadcast various media types, for example, video streams, audio streams, slide shows, live events, scheduled programming, archived (looped) content, games, premium media, entire email services and interactive media. Premium media includes, for example, a pay-per-view feature to allow the subscriber to view a special event in real time such as a live concert, or a sporting event, such as a boxing match, or an on-demand feature, which permits viewing of a prerecorded program, such as a movie, concert, television show or rerun, sports event or the like. Interactive media includes, for example, Internet telephony (VoIP), video conferencing, and instant messaging.

Interactive media also allows for the integration of feedback from the viewer with offered media or advertisements. For example, viewers may participate as an audience member or contestant in a game show, may vote on a series of choices (best costume, best design, favorite model), rate various acts in shows amenable to such a feature, or participate in distance learning programs. In another important feature of a preferred embodiment, a viewer can place bets (where legal to do so) on a sporting event, such as a horse race, auto race, or boxing or wrestling match selected for viewing. Blocking features may be provided to prevent unauthorized use of the premium media, or to block underage children from viewing or purchasing inappropriate program content.

Interactive media may also remain available to the user as the user navigates through a plurality of channels. Using these interactive features, the user may communicate with other users, for example, one-on-one, a user-selected group of subscribers, an interest-based group of users, or an event-based group of users, using instant messaging, chat rooms, voice messaging or video conferencing.

The service allows the user to navigate through a plurality of channels such as network cable, special interest, and public access channels, by utilizing a keyboard, remote control, voice control, or other input device connected to or wirelessly-enabled for use with the personal computer or other broadband enabled device accessing the service. The user can use the left and right cursor keys on the keyboard or the remote control arrow keys to change the channel. Alternatively, the user can directly key in the desired channel number and press enter to change to the desired channel. This system and method of broadcasting, displaying, and navigating Internet broadcasts allows the user to select and display a second channel featuring selected media content while still viewing in full screen the media content being broadcasted on the first channel. Essentially, this provides the user with the ability to simply change channels to view additional media content as if he were viewing the broadcasts on an actual television. In other words, the user is not forced to search or scroll through listings of available media content each time he wishes to view a different television show, video, or other broadcast. Instead, the user can continue viewing the media content on the first channel in full screen while selecting and displaying a second channel.

The user can also use the use the keyboard or remote control to control the display of the information panel. When the user first logs in to the service, the user interface 600 may display both the designated streaming broadcast 601 and the information panel 602 on the lower third of the screen, as shown in FIG. 6. The information panel may disappear after a specific number of seconds so that the user can view the broadcast in full screen without anything impeding the display of the media content in full screen. While viewing the broadcast on a specific channel, the user can utilize the down arrow on the keyboard or remote control in order to show the information panel and the up arrow on the keyboard or remote control to again hide the information panel. The user can utilize the escape key in order to exit the service and return to the launch screen.

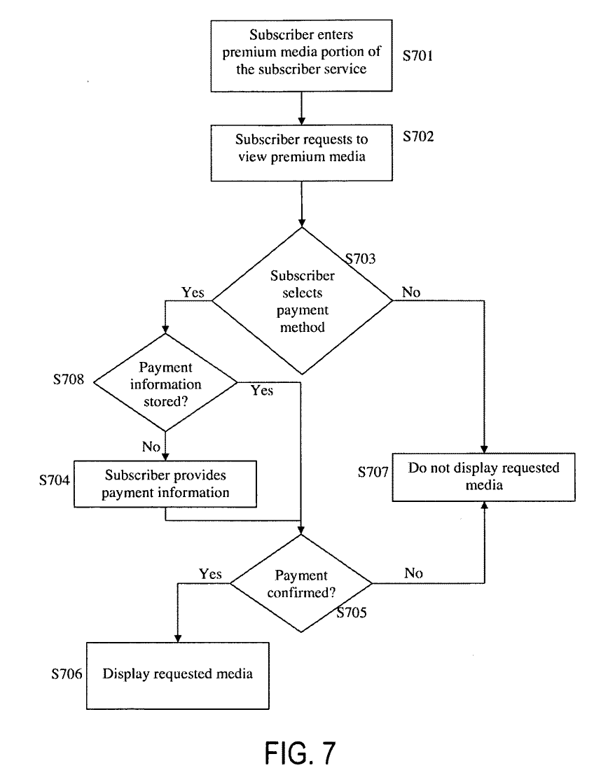

FIG. 7 is a flowchart demonstrating how a subscriber accesses premium media. The process will be described with reference also to FIGS. 1, 3 and 6. An individual 101 logged in as a subscriber (Step S305) goes to a channel or area offering premium media (Step S701). The subscriber requests to view premium media (Step S702), for example, by clicking on an icon or selection bar. The subscriber selects a payment method (Yes, Step S703), if the subscriber has stored payment data (Yes, Step S708), then that account is charged, otherwise (No, Step S708), the subscriber provides payment information (Step S704), is charged (Yes, Step S705), and the requested premium media is displayed (Step S706). If the subscriber is unable to provide payment for the premium media (No, Step S705), or otherwise decides not to provide the information (No, Step S703), then the premium media is not displayed (Step S707). Access charges for premium media may have many different structures, such as, for example, per-use, by package, by show, genre, or season, as well as on a time-sensitive basis, for example, where a movie may be rented for unlimited viewing for 24 hours.

In one embodiment of the invention, the service utilizes various forms of marketing, advertising and/or merchandising, for example, commercials that play before, during or in between broadcasts, banner ads, and advertising displayed in the lower third information panel. The commercials or advertisements can be interactive. The user can click on the advertisement or commercial in order to seamlessly view or share the advertisement or purchase a product or service being advertised.

In a further embodiment of the invention, the advertisements shown are targeted specifically targeted to the user. In other words, the advertisements or merchandise shown can be selected to fit the interests or profile of the user in order to most effectively generate revenue for advertisers by turning the user/viewer into a customer. The advertisements are targeted to the user based on, for example, the behavioral and demographic data provided by the user upon first subscribing to the service, or data collected relating to the subscriber's viewing habits or purchasing history. For example, a beer commercial might display along the bottom of the screen during a football game (live or rerun), or a perfume advertisement might be targeted to women viewers of a show or movie directed to women.

In addition, because every user must log into their subscription account in order to access the service, the service may gather detailed statistics about the viewership of various broadcasts that also help select the appropriate advertisement to show a particular subscriber. These statistics can also serve as valuable data to advertisers and to the companies who provide the media content by providing them with the business intelligence they need to most effectively reach a target audience of users/viewers. Such statistics include, for example, the number of users who watched a specific episode of a television program, the number of times each user viewed the episode, the number of individual segments of the episode that were played, the number of users who played the episode from start to finish, the number of initiated episodes per user through the on-demand service, the total number of minutes that were viewed by each user per episode, the total duration of time in which a user watched an episode, the number of users who watched the episode for 0-2 minutes, 3-5 minutes, 6-10 minutes etc., and the average peak number of viewers that watched an episode at once, and the number of times the channel was tuned into by users. The database collects this information in a form useful to advertisers, show producers, or others while maintaining the privacy of the subscriber.

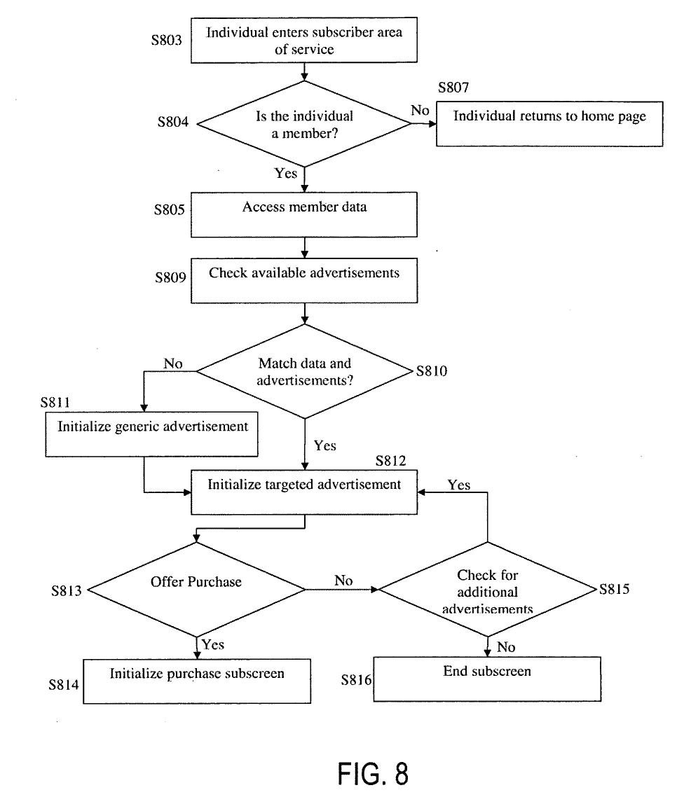

FIG. 8 is a flowchart demonstrating how the system of the present invention targets advertisements to the specific individual using the system. Referring to FIGS. 1 and 8, the individual 101 enters the subscriber area of the service 109 (Step S803) and signs on if he is a subscriber (Step S804). If the individual is not a subscriber (No, Step S807), the individual can return to the homepage, become a subscriber or exit. If the individual is a subscriber (Yes, Step S805), the service 109 will log the individual 101 into his/her subscriber account and access the data provided by the user when he first subscribed to the service (Step S805). The system then checks the available advertisements (Step S809), and matches the data provided by the user when he first subscribed to the service with data provided to identify the targets of the available advertisements (Step S810). If there is no match based on the data provided, the system will initialize and show a generic advertisement (No, Step S811). If there is a match, the system will initialize an advertisement specifically targeted to the user based on his behavioral and demographic data (Yes, Step S812). The system may then optionally offer the user to opportunity to purchase the item advertised (Step S813), for those advertisers that choose this feature. If the user chooses to purchase the item advertised, the system will initialize a purchase screen (Yes, Step S814). If the user chooses not to purchase the item advertised, the system will check for additional advertisements that match the user's data (No, Step S815), and display them at an appropriate interval or after a predetermined time. For example, during a live concert or boxing match televised on the pay-per-view portion of the system, the bottom third of the screen can offer for sale the latest CD of the performers, a download of one or more songs or videos, a souvenir t-shirt, an autographed photograph or other item during the concert, or a pair of autographed boxing gloves or an autographed photograph of the contestants, or a video of one or more of the matches, while the boxing match proceeds. Of course, a person of ordinary skill would recognize that the advertising may be presented as a banner along the top of the screen, or along one or both sides of the screen.

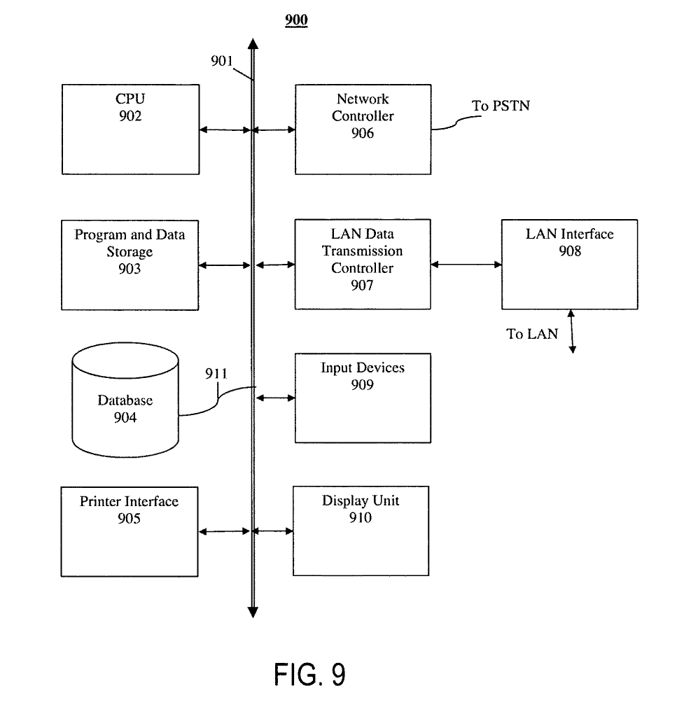

FIG. 9 illustrates an exemplary computer system 900 which may implement the present invention. The apparatuses and methods of the present invention may be implemented in the form of a software application running on a computer system, for example, a personal computer, handheld computer, mobile phone, personal digital assistant, or any device capable of connecting to the Internet using a broadband connection. The software application may be remote from the computer system and accessible via a hard wired or wireless connection to a network (for example, a local area network, or the Internet, etc.) or another transmission medium. The computer system 900 can include a central processing unit (CPU) 902, program and data storage devices 903, memory such as random access memory (RAM), a printer interface 905, a display unit 910, a local area network data transmission controller (LAN) 907, a LAN interface 908, a network controller 906, a system bus 901, and one or more input devices 909 (for example, a keyboard, mouse, remote control, etc.). As shown, the system may be connected to a database 904, via a link 911.

Numerous additional modifications and variations of the present disclosure are possible in vie of the above teachings. It is therefore to be understood that within the scope of the appended claims, the present disclosure may be practiced other than as specifically described herein.

What is claimed is:

1. A method for broadcasting, displaying, and navigating Internet applications comprising:
(a) providing an Internet application;
(b) displaying a sign-on screen to permit user identification;
(c) permitting a user to sign on;
(d) streaming to the user a plurality of media content choices, each media content choice forwarded over a broadband connection to a user location;
(e) permitting a user to select a first media content choice for display;
(f) forwarding for display the first media content choice in response to user selection on a display attached to a personal computer or other broadband capable receiver or display; and
(g) forwarding for display a second or subsequent media content choice sequentially in response to a second or subsequent user selection,
wherein the user can display each of the plurality of media content choices sequentially in full screen format on the display of the user.

2. The method of claim 1, wherein the user can navigate through the media content choices by using keys on a keyboard or a joystick.

3. The method of claim 1, wherein the user can navigate through the channels by using a remote control.

4. The method of claim 1, wherein the user can navigate through the channels by using a voice control.

5. The method of claim 1, wherein the media content is a video stream, audio stream, live broadcast, scheduled programming, Internet telephony, instant messaging, video conferencing, on-demand programming, pay-per-view programming, or other Internet addressable resource/object.

6. The method of claim 1, wherein the user can interact with other users while viewing selected media content by Internet telephony, instant messaging, or video conferencing.

7. The method of claim 1, wherein the user can interact with media programming by Internet telephony, instant messaging, or video conferencing.

8. The method of claim 1, wherein user feedback is integrated with the media.

9. The method of claim 1, wherein user information and actions are collected, recorded, transmitted, or reported.

10. The method of claim 1, wherein advertising media, interactive marketing, advertising, or merchandising is provided on a lower or upper portion of the video monitor.

11. The method of claim 9, wherein the advertising media, interactive marketing, advertising, or merchandising is specifically targeted to the user based on information collected about the user.

12. The method of claim 1, wherein the media content is displayed in high definition format.

13. The method of claim 1, wherein the user can interact with media programming by Internet telephony, instant messaging, or video conferencing.

14. The method of claim 1, wherein user feedback is integrated with the media content.

15. The method of claim 1, wherein an information panel simultaneously displays various types of information and content.

16. An apparatus for broadcasting, displaying, and navigating Internet broadcasts comprising:
(a) an Internet application;
(b) a plurality of channels featuring media content; and
(c) a video monitor or a screen attached to a personal computer or other broadband receiver or display,
wherein a user can navigate through the plurality of channels while viewing the media content featured on each channel in full screen format on the monitor or display.

17. The apparatus of claim 16 further comprising means to navigate through the channels using a keyboard or a joystick.

18. The apparatus of claim 16 further comprising means to navigate through the channels using a remote control.

19. The apparatus of claim 16 further comprising means to navigate through the channels using voice control or command.

20. The apparatus of claim 16 wherein the media content is displayed in high definition format.

21. The apparatus of claim 16, wherein the media content is a video stream, audio stream, live broadcast, scheduled programming, on-demand programming, pay-per-view programming, or other Internet addressable resource or object.

22. The apparatus of claim 16 wherein the user can interact with other users via Internet telephony, instant messaging, or video conferencing on a particular channel or while viewing the media content.

23. The apparatus of claim 16, wherein user information and actions are collected, recorded, transmitted or reported.

24. The apparatus of claim 16, wherein interactive marketing, advertising, and merchandising is provided.

25. The apparatus of claim 16, wherein interactive marketing, advertising, and merchandising is specifically targeted to the user based on information collected, recorded, transmitted, or reported about the user.

26. An apparatus for broadcasting and allowing selection among a plurality of Internet video streams comprising:
at least one server having software for providing and supporting a service including an Internet application with access to a plurality of choices among different media content;
the server also having software for navigating between media content choices by providing a selection of assigned indicia representing channels or media content choices;
wherein the server generates user screens that permit navigation through the plurality of media content choices by selecting the assigned indicia using a keyboard, a numeric keypad, or a joystick, whereby selecting media content choices resembles conventional television channel selection.
